(19) United States
(12) Patent Application Publication
(10) Pub. No.: US 2023/0180779 A1
(43) Pub. Date: Jun. 15, 2023

(54) FERMENTED CREAM CHEESE COMPOSITION WITH HIGH PROTEIN CONTENT

(71) Applicant: GROUPE LACTALIS, Laval (FR)

(72) Inventors: Alain HOUDOUX, Laval (FR); Thibault LOISELEUX, Laval (FR); Anna OLIW, Laval (FR); Stefan BORG, Laval (FR); Richard LOFGREN, Laval (FR)

(73) Assignee: GROUPE LACTALIS, Laval (FR)

(21) Appl. No.: 17/925,130

(22) PCT Filed: May 12, 2021
(86) PCT No.: PCT/EP2021/062761

§ 371 Date: Nov. 14, 2022

(30) Foreign Application Priority Data
May 14, 2020 (FR) FR2004788

(51) Int. Cl. A23C 19/076; A23C 19/09; A23J 1/20; A23L 33/19

(52) U.S. Cl. CPC A23C 19/076; A23C 19/0917; A23J 1/202; A23L 33/19

(57) ABSTRACT

A spoonable fermented cream cheese composition with high protein content, of the quark or skyr type, intended for persons requiring increased intakes of proteins, such as sportspersons and elderly persons. The composition comprises at least 8% by weight proteins, with respect to the total weight of the composition, the proteins consisting of a mixture of casein and milk serum proteins in a weight ratio between 50/50 and 75/25, the milk serum proteins comprising at least 20% denatured serum proteins in the form of microparticles, by weight with respect to the total weight of the serum proteins, and in that the pH is less than or equal to 4.6.

The present invention relates to a spoonable fermented fromage frais composition with a high protein content, of the quark or skyr type, intended for persons requiring increased protein intakes such as sportspersons and elderly persons.

The market for high-protein-content products, i.e. those having a protein content above 8%, is developing, in particular in Europe and North America.

Thus nutritional compositions, specifically adapted for the condition of persons such as elderly persons, persons in a state of malnutrition or sportspersons, are being developed and offered in order to provide them with the nutritional compounds meeting their requirements and which they do not find, or not in sufficient quantity, in their diet. The purpose of such complementation is to provide mainly proteins.

In a sportsperson, protein-rich nutritional compositions are used in order to provide the proteins necessary for supporting physical activity for better recovery.

Another purpose of protein complementation is renutrition of a malnourished person or the anticipation of a malnourished state liable to occur in the case of hospitalisation or illness. In the process of aging, elderly persons are more sensitive to a state of malnutrition because of physiological changes related to age, illness, handicap, cognitive problems or loss of sense of taste. Malnutrition can be defined as a dietary imbalance between intake and requirements. It gives rise to many deficiencies and increases the sarcopenia syndrome, a gradual reduction in strength and mass of skeletal muscles related to age.

Protein-enriched nutritional compositions used in such situations include, as sources of proteins, proteins of milk origin such as caseins and serum proteins coming from milk or proteins of plant origin such as soya proteins. As understood here, the expression “serum proteins” refers to lactoserum proteins. Among these protein sources, lactoserum proteins prove to be advantageous on a nutritional level and are so-called rapid-digestion proteins, i.e. the amino acids appear quickly and in high concentration in the blood plasma. Conversely, casein has slower digestion.

Lactoserum proteins are rich in essential amino acids but also in branched-chain amino acids such as leucine, isoleucine and valine. Essential amino acids are amino acids that cannot be synthesised endogenously by the organism.

In addition, studies reveal that the high leucine content in lactoserum proteins appear to have a role in the prevention of sarcopenia, by regularising the renewal of proteins during aging and helping to maintain muscle mass. In this regard, lactoserum proteins have proved to be effective in stimulating muscle synthesis (Farnfield et al., 2005).

Apart from preventing sarcopenia, lactoserum proteins prove to be advantageous for sportspersons by helping them to maintain and develop their muscle mass.

Numerous protein-rich nutritional compositions are on offer at the present time. It is a case in particular of compositions in the form of drinks or dessert creams. With regard to desserts, these are flavoured creams, having fruit, coffee or chocolate flavours.

However, there still remains the need to broaden the protein-rich products on offer by offering products that are both effective and similar to conventional food products. Fermented fromage frais of the quark or skyr type are interesting in this regard.

Quark, also known by the name “quarg” or “speisequark”, is a milk product of the fermented fromage frais type. This product is obtained by pasteurising milk and fermenting it and/or adding coagulant until the curdling phenomenon occurs. This product is mainly found on the market in Northern Europe countries.

However, fermented fromage frais with a high protein content does not have satisfactory organoleptic characteristics for consumers.

This is because these products have texture problems, since they may be sticky, too firm or too consistent. In the light of the characteristics of these products, the dietary intake is small, and consequently the protein intake is insufficient to give rise to a significant nutritional action adapted for elderly persons, malnourished persons and sportspersons.

By way of example, products of the quark type with 12% protein are found on the market. These products have a problem of texture and consistency because of its composition that is excessively rich in protein. It also has an only moderately interesting nutritional profile because of an excessively small quantity of serum protein.

The European patent EP 2 675 281 for its part describes preparing products such as quarks based on caseins and serum proteins in a casein/lactoserum ratio of 50/50. With such a ratio, problems of phase separation and high viscosity can probably be observed.

The invention sets out to solve all the aforementioned problems.

One of the aims of the present invention is thus to propose a fermented fromage frais composition with a high protein content that has organoleptic properties acceptable to the consumer, in particular a smooth texture, especially a flexible and pleasant texture, without any phenomenon of phase separation, a protein profile that is advantageous on a nutritional level, the composition being intended both for active and sportive persons and for elderly or even malnourished persons.

For this purpose, the invention relates to a spoonable fermented fromage frais composition, of the quarg or quark or skyr type, characterised in that it comprises:
at least 8% by weight proteins, with respect to the total weight of the composition,
the proteins consisting of a mixture of casein and milk serum proteins in a weight ratio of 50/50 to 75/25,
the milk serum proteins comprising at least 20% denatured serum proteins in the form of microparticles, by weight with respect to the total weight of the serum proteins,
the pH of the composition being less than or equal to 4.6.

The composition according to the invention has an advantageous serum protein content with regard to nutritional intake, in particular for sportspersons and elderly persons. The quantity of serum proteins in the composition is specifically adjusted so as not to observe a phenomenon of phase separation.

The composition according to the invention also has good organoleptic characteristics, with a flexible and pleasant texture, as well as a creamy taste, by virtue of the addition of denatured serum proteins in the form of microparticles.

Advantageously, the milk serum proteins comprise at least 35%, preferentially at least 40% serum proteins in the form of microparticles, by weight with respect to the total weight of the serum proteins.

According to a preferred embodiment of the invention, the ratio between the casein and the serum proteins is 70/30.

At such a ratio, the organoleptic characteristics such as the improvement in smoothness are well perceived by the consumer.

Preferentially, at such a ratio, the serum proteins comprise between 20 and 35% serum proteins in the form of microparticles, by weight with respect to the total weight of serum proteins.

According to another preferred embodiment of the invention, the ratio between the casein and the serum proteins is 55/45.

Such a ratio also favours the nutritional aspect of the product as well as the texture, in particular the smoothness.

Preferentially, at such a ratio, the serum proteins comprise more than 35% serum proteins in the form of microparticles, by weight with respect to the total weight of serum proteins.

According to one embodiment, the denatured serum proteins in the form of microparticles have a mean diameter greater than 1 µm, preferentially greater than 2.5 µm.

The sizes of the microparticles are measured by laser diffraction using a Mastersizer 3000 granulometer (Malvern, Almelo, Netherlands and Malvern, United Kingdom) using two monochromatic lasers with a wavelength of 470 and 632.8 nm.

According to one embodiment, the composition comprises at least 10%, preferentially at least 12%, and more preferentially more than 14% proteins, by weight with respect to the total weight of the composition.

According to one embodiment, the composition comprises no more than 5% carbohydrates, by weight with respect to the total weight of the composition.

According to one embodiment, the composition comprises no more than 5% fat, by weight with respect to the total weight of the composition.

According to one embodiment, the composition comprises one or more lactic bacteria, one or more texturing agents, one or more dyes, one or more flavourings.

According to one embodiment, the composition has a viscosity of less than 7 Pa.s measured at a shearing speed of 50 s⁻¹ at 6° C.

The viscosity is measured by means of an MCR300 rheometer (Anton Paar, Graz, Austria) equipped with a cone-plate geometry (CP50-4; diameter 50 mm).

The viscosity obtained is thus at least 10% less compared with that of a conventional quark, skyr or fromage frais having a conventional ratio of caseins to serum proteins of 80:20 at the same total protein content.

The invention also relates to a method for preparing a composition of fromage frais resulting from milks of all animal species as described previously, the method comprising the following steps:
a step of preparing a fromage frais,
a step of obtaining denatured and microparticulated serum proteins,
a step of mixing 60 to 95% fromage frais and 5 to 40% serum proteins comprising at least 20% denatured serum proteins in the form of microparticles, by weight with respect to the total weight of serum proteins.

The fromage frais is prepared in accordance with any of the methods well known to a person skilled in the art. By way of example, the method may comprise the following steps:
obtaining a skimmed milk,
pasteurising, preferentially at 90° C., for 5 minutes,
fermenting, preferably at 30° C., for 14 h, at pH 4.6,
thermising, preferentially at 60° C., for 1 minute,
separating the curds by any physical means, preferentially at 50° C.,
cooling the curds, preferentially at 15° C.

Once the curds are cooled, cream can optionally be added, as well as yoghurt.

The serum proteins comprising at least 20% serum proteins in microparticle form, by weight with respect to the total weight of the serum proteins, are then added to the curds.

The invention also relates to the use of a composition as defined above for the nutritional supplementation of sporting or elderly persons, in particular for protein supplementation or renutrition.

The invention will be better understood from the reading of the example embodiments that follow, which are intended to be illustrative and non-limitative.

### EXAMPLE 1: RHEOLOGY STUDY

Rheology studies were performed on the following four fromage frais compositions:
MP11% ratio cas/PS 80/20: Fromage frais composition at 11% proteins; ratio casein/non-microparticulated serum proteins of 80/20.
MP12% ratio cas/PS 80/20: Fromage frais composition at 12% proteins; ratio casein/non-microparticulated serum proteins of 80/20.
MP12% ratio cas/PS 70/30: Fromage frais composition at 12% proteins; ratio casein/denatured and microparticulated serum proteins of 70/30.
MP12% ratio cas/PS 50/50: Fromage frais composition at 12% proteins; ratio casein/non-microparticulated serum proteins of 50/50.
MP13% ratio cas/PS 70/30: Fromage frais composition at 13% proteins; ratio casein/denatured and microparticulated serum proteins of 70/30.
MP13% ratio cas/PS 50/50: Fromage frais composition at 13% proteins; ratio casein/denatured and microparticulated serum proteins of 50/50.
MP14% ratio cas/PS 70/30: Fromage frais composition at 14% of proteins; ratio casein/denatured and microparticulated serum proteins of 70/30.
MP14% ratio cas/PS 50/50: Fromage frais composition at 14% proteins; ratio casein/denatured and microparticulated serum proteins of 50/50.
MP15% ratio cas/PS 50/50: Fromage frais composition at 15% proteins; ratio casein/denatured and microparticulated serum proteins of 50/50.

The flow curves were produced by means of an MCR300 rheometer (Anton Paar, Graz, Austria) equipped with a cone-plate geometry (CP50-4; diameter 50 mm) in the shearing range from 1 to 350 s⁻¹ at 6° C.

The viscosities at 50 s⁻¹ at 6° C., the most representative of the perception in the mouth of consumers, are indicated in Table 1 below:

TABLE 1

| | Viscosity at 50 s⁻¹ (Pa.s) |
|---|---|
| MP11% ratio cas/PS 80/20 | 4.95 |
| MP12% ratio cas/PS 80/20 | 7.78 |
| MP12% ratio cas/PS 70/30 | 3.65 |
| MP12% ratio cas/PS 50/50 | 3.05 |
| MP13% ratio cas/PS 70/30 | 5.38 |
| MP13% ratio cas/PS 50/50 | 4.27 |
| MP14% ratio cas/PS 70/30 | 6.89 |
| MP14% ratio cas/PS 50/50 | 5.17 |
| MP15% ratio cas/PS 50/50 | 5.69 |

The composition MP12% ratio cas/PS 80/20 has a viscosity level greater than the viscosity sought and is therefore not accepted by consumers.

All the other compositions have viscosities below the acceptability limit of the consumers fixed at 7 Pa.s at 6° C.

It should be noted that, the more the protein content increases, the more adapted is the 50/50 ratio, making it possible to obtain a pleasant and stable texture (no phase separation).

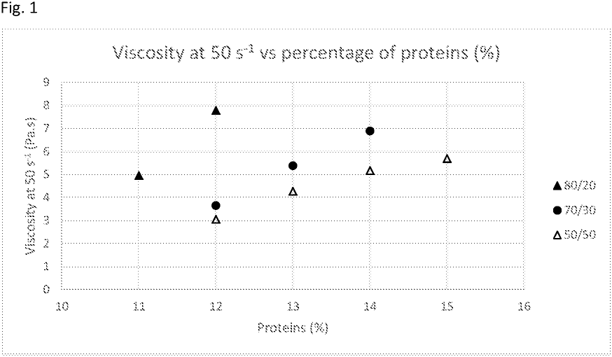

In addition, FIG. 1 illustrates graphically the information in table 1.

1. Spoonable fermented cream cheese composition, of the quark or skyr type, comprising:
- at least 8% by weight proteins, with respect to the total weight of the composition,
the proteins consisting of a mixture of casein and milk serum proteins in a weight ratio of between 50/50 and 75/25,
the milk serum proteins comprising at least 20% denatured serum proteins in the form of microparticles, by weight with respect to the total weight of the serum proteins,
and the pH is less than or equal to 4.6.

2. Composition according to claim 1, wherein the ratio between casein and the milk serum proteins is 70/30.

3. Composition according to claim 1, wherein the ratio between the casein and the milk serum proteins is 55/45.

4. Composition according to claim 1, wherein the serum proteins comprise at least 35%, serum proteins in the form of microparticles, by weight with respect to the total weight of serum proteins.

5. Composition according to claim 1, wherein the serum proteins in the form of microparticles have a mean diameter greater than 1 µm.

6. Composition according to claim 1, comprising at least 10% , by weight, with respect to the total weight of the composition.

7. Composition according to claim 1, comprising no more than 5% carbohydrates by weight, with respect to the total weight of the composition.

8. Composition according to claim 1, comprising no more than 5% fat, by weight, with respect to the total weight of the composition.

9. Composition according to claim 1, comprising one or more lactic bacteria, one or more texturing agents, one or more dyes, one or more flavourings.

10. Composition according to claim 1, wherein it has a viscosity of less than 7 Pas.s measured at a shearing speed of 50 s⁻¹ at 6° C.

11. Composition according to claim 1, for use thereof in the nutritional supplementation of sporting or elderly persons.
